(19) United States
(12) Patent Application Publication
(10) Pub. No.: US 2012/0135104 A1
(43) Pub. Date: May 31, 2012

(54) Enhanced Absorption of Omega Fatty Acid Oils

(76) Inventor: Bhiku Patel, Chandler, AZ (US)

(21) Appl. No.: 12/956,659

(22) Filed: Nov. 30, 2010

(51) Int. Cl. A23D 7/00

(52) U.S. Cl. 426/2; 426/601

(57) ABSTRACT

A composition for increasing the bioavailability of oils in humans and animals comprising mixing a first emulsifier and a second emulsifier in a ratio ranging from about 1:1 to about 3:1 with a consumable oil wherein the first emulsifier is polyoxyethylene sorbitan monooleate and the second emulsifier is tocopheryl polyethylene glycol succinate. A method for increasing the bioavailability of such a composition is also provided.

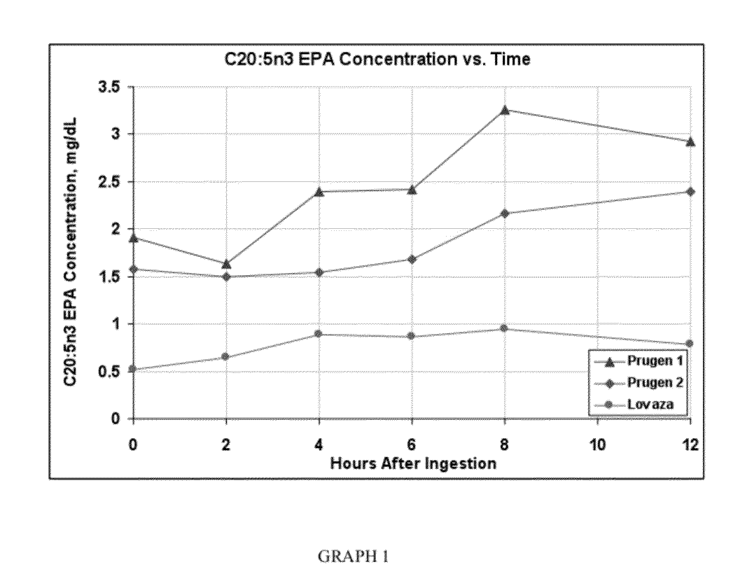

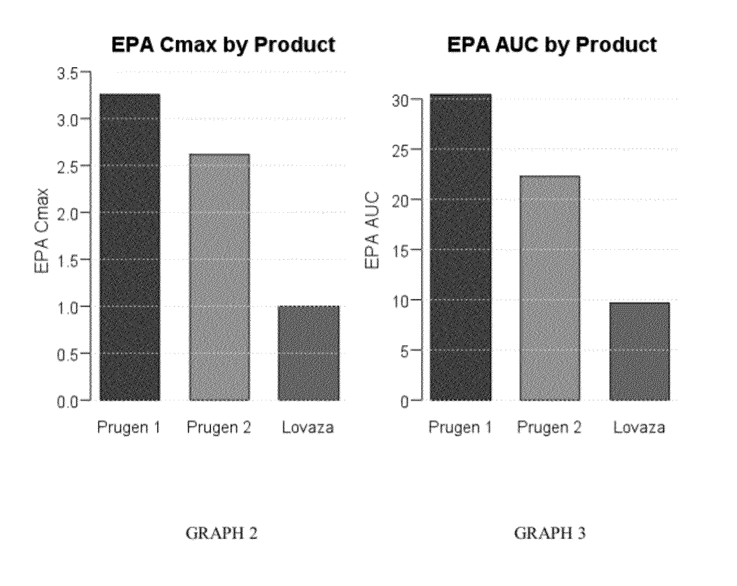

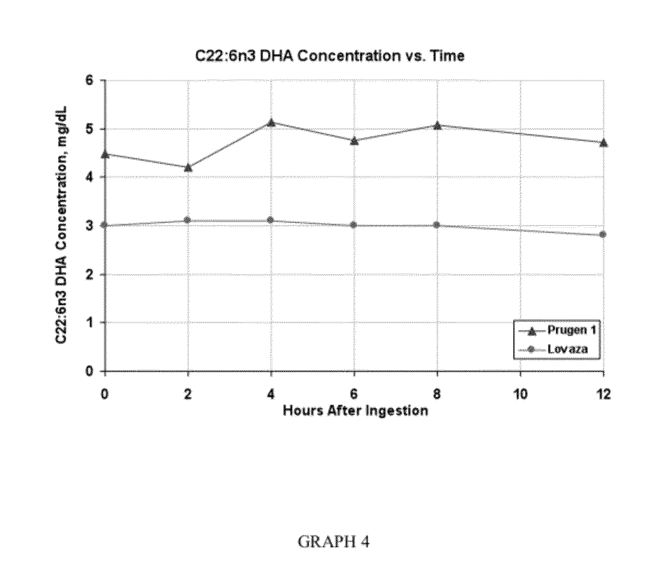

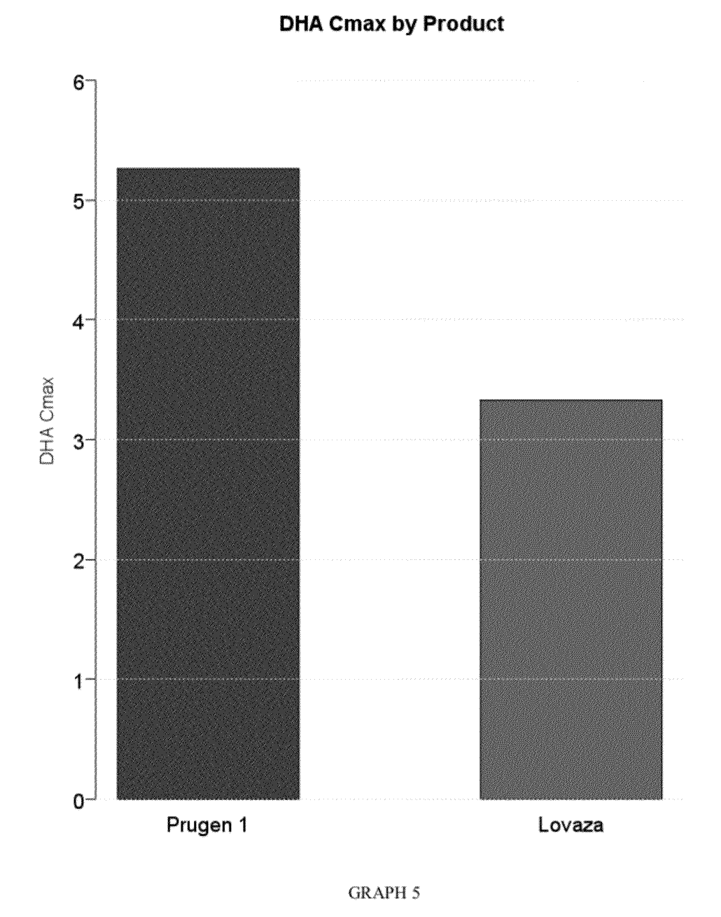

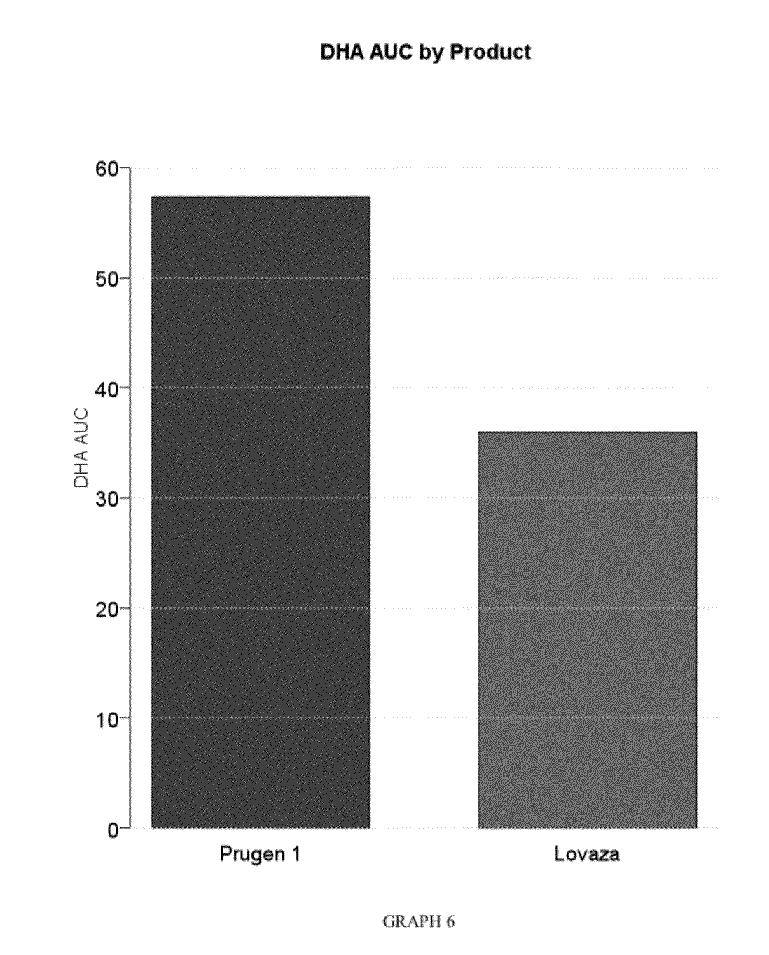

### I. INCORPORATION BY REFERENCE

This application incorporates by reference the full content of application Ser. No. 12/906,419 filed Oct. 18, 2010.

### II. TECHNICAL FIELD

The present invention relates to the absorption of oils consumed by humans or animals and, more particularly, to a composition that enhances the bioavailability of the oil through the mixing of the oil with certain emulsifiers.

### III. BACKGROUND OF THE INVENTION AND PRIOR ART

Consumable oils containing omega fatty acids have gained acceptance as having significant health benefits. As the results of multiple studies, it is now generally accepted that omega oils have a measurable positive impact on cardiovascular health. More recent studies show promise in the use of these oils for controlling blood pressure, aiding in the treatment of diabetes mellitus, and assisting in bone structure maintenance. There is further evidence mounting for the use of these oils in other areas of health, including, for example, brain function, arthritis, immune system maintenance, and cancer prevention.

Omega fatty acids are essential fatty acids (“EFA”) as they are required for good nutritional balance but they are not produced by the body; they must be obtained from other sources. These essential fatty acids are found in many sources, including fish and crustacean marine sources, plants, algae, and animals.

The two main categories of omega fatty acids are omega-3 and omega-6. The Omega-3 fatty acids are alpha-linolenic acid (“ALA”), stearidonic acid, eicosapentaenoic acid (“EPA”) and docosahexaenoic acid (“DHA”). Alpha-linolenic acid is found mainly in flaxseed oil, canola oil, soybeans, walnuts, hemp seeds, and dark green leafy vegetables. Stearidonic acid is found in rarer types of seeds and nuts, including black currant seeds. EPA and DHA are present in cold-water fish, including salmon, trout, sardines, anchovies, mackerel and cod.

Omega-6 fatty acids are more common in the American diet than the Omega-3 EFAs. These include linoleic acid , which is found in safflower, olive, almond, sunflower, hemp, soybean, walnut, pumpkin, sesame, and flaxseed oils; Gamma-linolenic acid (GLA), which is found in some seeds and evening primrose oil; and, arachidonic acid (AA) which is present in meat and animal products.

Both types of EFAs, Omega-3 and Omega-6 fatty acids, are necessary in a healthy diet. However, it has been observed that deficiencies in EFAs have occurred over the years. This is more so true with the Omega-3 fatty acids for the reason that most Westerns may get an adequate amount of Omega-6 through the consumption of meat products, but do not ingest enough Omega-3 fatty acids due to lower consumption of fish, seeds, and vegetables.

This has a vicious cycle effect because not only are both types of EFA necessary for good health, Omega-6 fatty acids negatively affect the metabolism of Omega-3 fatty acid, thereby all but negating the Omega-3 fatty acids that are consumed, and an over abundance of Omega-6 fatty acids may cause an increase in prostaglandin product which, in excessive amounts, can have deleterious health effects. Experts recommend that omega-3 and omega-6 EFAs be present in the diet in a ratio of around one to three. Americans, for example, consume a ratio as high as one to 40. Thus, the need for greater amounts of omega-3 EFAs in the diet has increased.

This has resulted in a push to increase the dietary intake of Omega-3 fatty acids. While the push has been to have people eat a healthy diet, often it is either not possible or, more often, it does not happen. Accordingly, people turn to dietary or medicinal help. As a result, Omega-3 dietary supplements and, to a lesser degree, omega-3 containing medications, have become a staple in many households.

Consumer complaints regarding these supplements and medications are that they are too large and therefore uncomfortable to take and that they are unpalatable because of taste. From a scientific standpoint there is interest in making as much of the EFA bioavailable as possible so as to get the maximum effect in a short amount of time.

Attempts to address these issues have, until now, mainly revolved around purifying the oil to make it higher quality with the goal to reduce the amount of oil having to be consumed and to reduce the after-taste. From a scientific standpoint, not much research has gone into increasing the bioavailability and absorption of the oil, and, following, the EFA.

Accordingly, there is need for a composition that increases the bioavailability of EFAs and other consumable oils while at the same time shortening the time for absorption, and potentially reducing the amount of oil necessary to be consumed in order to obtain a desired result. Such a composition is provided for in the present invention.

### IV. OBJECTS AND ADVANTAGES OF THE PRESENT INVENTION

It is an object of the present invention to provide a composition that enhances the bioavailability of a consumed oil.

It is further an object of the present invention to provide a composition that shortens the time of absorption of a consumed oil.

It is further an object of the present invention to provide a finely dispersed oil consumption.

It is further an object of the present invention to enable the reduction in the amount of a consumed oil to be consumed.

The advantages offered by the present invention include but are not limited to maximizing the amount of bioavailable consumed oil.

### VI. SUMMARY OF THE INVENTION

The present invention comprises a composition for increasing the bioavailability of oils in humans and animals comprising adding a first emulsifier and a second emulsifier in a ratio ranging from about 1:1 to about 4:1, preferably, the first emulsifier and the second emulsifier are mixed in a ratio of about 2:1, and a consumable oil, with the final mixture of the three ingredients being in a ratio ranging from about 99:1 to about 9:1. Preferably, the ratio of the two emulsifiers together and the consumable oil is about 12.333:1. Preferably, the first emulsifier is polyoxyethylene sorbitan monooleate and the second emulsifier is tocopheryl polyethylene glycol succinate. The consumable oil can be of any type, with currently known sources being animal oils, vegetable oils, marine-based oils, and algae oils. The oils can be used either singly or in combination with one another.

Through the use of the inventive composition, a corollary to increasing the bioavailability of the consumable oil is that it reaches the blood steam more quickly than either purified oil alone or a prescription fish oil based medication.

Using the inventive composition results in levels of oil blood stream concentrations, as measured by EPA levels, of about 250% over that of purified fish oil and about 400% over that of a prescription fish oil based medication, or about 0.253 mg/dl/hr versus 0.10 mg/dl/hr of purified fish oil and 0.06 mg/dl/hr for the prescription fish oil based medication based upon a gram intake.

There has been outlined, rather broadly, the more important features of the invention in order that the detailed description thereof that follows may be better understood, and in order that the present contribution to the art may be better appreciated. There are, of course, additional features of the invention that will be described hereinafter and that will form the subject matter of the invention.

### VII. BRIEF DESCRIPTION OF THE DRAWINGS

Graph Number 1 depicts EPA blood level Concentration vs Time (Hrs) for the inventive composition compared with purified fish oil alone and with a prescription fish oil based medication.

Graph Number 2 depicts the maximum EPA blood level concentration for the inventive composition compared with purified fish oil alone and with a prescription fish oil based medication.

Graph Number 3 depicts the maximum EPA AUC for the inventive composition compared with purified fish oil alone and with a prescription fish oil based medication

Graph Number 4 depicts DHA blood level Concentration vs Time (hrs) for the inventive composition compared with prescription fish oil based medication.

Graph Number 5 depicts the maximum DHA blood level concentration for the inventive composition compared with prescription fish oil based medication.

Graph Number 6 depicts the maximum DHA AUC for the inventive composition compared with a prescription fish oil based medication.

### VIII. DETAILED DESCRIPTION OF THE PREFERRED EMBODIMENTS

Before explaining the preferred embodiment of the present invention in detail, it is to be understood that the present invention is not limited in its application to the details of formulations and arrangements of the components set forth in the following description. The present invention is capable of other embodiments and of being practiced and carried out in various ways. Also, it is to be understood that the phraseology and terminology employed herein are for the purpose of description and should not be regarded as limiting. It is also to be understood that where ranges are provided for the various agents and drug examples, they are approximate ranges and are not to be limiting except where noted otherwise.

The present invention addresses the problem of consumable oil bioavailability. To overcome limitations in absorption and bioavailability of such oils, the Inventor has discovered that creating a finely dispersed micro-emulsion in turn creates an increase in oil surface area per volume, thereby enabling greater gastrointestinal uptake of the oil. Through the use of emulsifiers that do not create a permanent binding to the oil, the bioavailability of the fish oil is increased.

The consumable oils contemplated by the invention include oils from the vast variety of sources, including without limitation, marine (such as fish and crustacean), animal, plant, and algae. Principally, the oils are selected for their Omega fatty acid content, and as is the current trend, Omega-3 fatty acids. Among the Omega-3 fatty acids in current demand are eicosapentaenoic acid (“EPA”) and docosahexaenoic acid (“DHA”). While Omega-3 fatty acids and EPA and DHA are used throughout, this is in no way meant to limit the scope and spirit of the invention. As those skilled in the arts will quickly understand, the principles taught herein will apply to any consumable oil, whether it contains Omega-3 fatty acid or not. For non-limiting example, other essential fatty acids include Omega-6 fatty acids, will also work well within the principles of the Invention.

To create a micro-emulsion adequate to provide the necessary results, the Inventor discovered that two emulsifiers are required. A first emulsifier should be a nonionic surfactant and emulsifier. There is a wide range of such emulsifiers from which to choose. Key to the selection is that the first emulsifier be suitable for human or animal ingestion (throughout, the terms consumption and ingestion are used interchangeable and mean to take orally.) The Inventor has discovered that the preferred first emulsifier is polyoxyethylene sorbitan monooleate.

A second emulsifier is also required. The Inventor has discovered that employing esterfied Vitamin E works well. While esterfied Vitamin E in its various forms may be employed in the invention, the Inventor has discovered that the preferred form is tocopheryl polyethylene glycol succinate.

Both of the preferred emulsifiers are well known in the industry. Polyoxyethylene sorbitan monooleate has been used for many years in the food and pharmaceutical industries. It is most commonly sold under the trade name polysorbate 80 and is widely available. It is approved by the U.S. Food and Drug Administration as an inactive ingredient and is well tolerated in oral compositions. Tocopheryl polyethylene glycol succinate is sold by several companies but was first developed by the Eastman Company and sold under the trademark ‘Vitamin E TPGS NF.’ It was developed as a water soluble emulsifier to aid in the absorption of lipid-based drugs, such as cyclosporin. Since its invention, it has been used in many products.

However, until the present invention the combination use of polyoxyethylene sorbitan monooleate and tocopheryl polyethylene glycol succinate to enhance the bioavailability of consumable oils has not been taught.

Individually, each of these emulsifiers will cause at least some dispersion but it is the heretofore unknown mixture of the two emulsifiers and oil that creates the micro-emulsion necessary to increase the bioavailability of the oil. Using the Inventive Composition, a fine micro-emulsion is created that enables almost complete dispersion in water, a result unseen with either of the two emulsion separately or known in the prior art. The result is gained by the emulsion properties of the tocopheryl polyethylene glycol succinate to create a fine dispersion and the polyoxyethylene sorbitan monooleate to reduce further the interfacial tension that then enables an oil-in-water micro-emulsion of a level not heretofore seen in the art.

When considering the selection of emulsifiers to use in combination to create a suitable micro-emulsion, the Inventor discovered that surface activity of the emulsifiers on the oil was an important element. Increasing the surface area of the oil enabled increased bioavailability but only to a point. Once surface area exceeds a certain value, no additional benefit is gained in absorption and, therefore, bioavailability. In fact, bioavailability can be decreased.

To determine the suitable range of surface area activity, the Inventor employed hydrophilic lipophilic balance (HLB) values. HLB is a widely accepted method for providing a measure of the surface activity of organic molecules. HLB values for emulsifiers range from about 2 to about 40. The Inventor discovered that emulsifiers in the range of about 10 to about 30 are suitable for use with the invention, with a range of about 12 to about 16 providing the best results.

Polyoxyethylene sorbitan monooleate has an HLB value of about 15 and tocopheryl polyethylene glycol succinate has an HLB value about 13. Thus, the average HLB value for the combination of the two emulsifiers is about 14 when they are found in a 1:1 polyethylene glycol succinate: tocopheryl polyethylene glycol succinate ratio and about 14.6 when they are in a 4:1 polyethylene glycol succinate: tocopheryl polyethylene glycol succinate ratio. Accordingly, the preferred HLB range is from about 14 to about 14.6.

To demonstrate the effectiveness of the combination of these two emulsifiers and consumable oils, the Inventor developed an experiment to illustrate the increased bioavailability of consumable oil, using EPA and DHA as markers. In the experiment, subjects were cleared of blood stream detectable levels of EPA and DHA. The Human subjects were then randomly given either the Inventive composition, a purified fish oil, or a fish oil-based prescription medication under physician supervision. Blood level readings for both EPA and DHA were then taken at 2, 4, 6, 8, 10, and 12 hours.

Turning to Graph Number 1, it can be seen that EPA levels for the inventive composition were significantly above those for both the purified fish oil and the prescription medication at every reading. The following table 1 illustrates the rate of blood level concentration (mg/dl/hr) for each of the three test materials:

TABLE 1

| Inventive Composition | Purified Fish oil | Prescription Medication |
|---|---|---|
| 0.253 | 0.10 | 0.06 |

Turning to Graph Number 2, it can be seen that the maximum blood concentration (Cₘₐₓ) for the Inventive Composition EPA is also greater than that of the purified fish oil and the prescription medication. The following table 2 shows the Cₘₐₓ (mg/dl) for each of the three test materials:

TABLE 2

| Inventive Composition | Purified Fish oil | Prescription Medication |
|---|---|---|
| 3.27 | 2.62 | 1.00 |

Graph Number 3 illustrates the Area Under Curve (AUC) for the three test materials and, again demonstrates the superiority of the Inventive Composition. Table 3 shows the average AUC₀₋₁₂ (mg/dl/hr) for the three test materials:

TABLE 3

| Inventive Composition | Purified Fish oil | Prescription Medication |
|---|---|---|
| 30.40 | 22.30 | 9.70 |

DHA readings were then taken to further demonstrate the Inventive Composition effectiveness. Turning to Graph 4, it can be seen that DHA levels for the inventive composition were significantly above those of the prescription medication at every reading.

Turning to Graph Number 5, it can be seen that the maximum blood concentration (Cₘₐₓ) for the Inventive Composition DHA is also greater than that of the prescription medication. The following table 4 shows the Cₘₐₓ (mg/dl) for the two test materials:

TABLE 4

| Inventive Composition | Prescription Medication |
|---|---|
| 5.26 | 3.34 |

Graph Number 6 illustrates the Area Under Curve (AUC) for the two test materials and, again demonstrates the superiority of the Inventive Composition. The AUC₀₋₁₂ for the Inventive Composition is 57.3 mg/dl/hr. and for the prescription medication is 33.0 mg/dl/hr.

In mixing of the two emulsifiers with oil to create a more bioavailable oil, the ratios of the two emulsifiers and oil in creating an end product with maximum effectiveness at a minimum use of emulsifiers have been considered. The Inventor has discovered that an emulsifier ratio in the range of polyoxyethylene sorbitan monooleate:tocopheryl polyethylene glycol succinate of about 1:1 to about 4:1 is useful. The preferred ratio is 2:1.

In mixing the three components together, the emulsifier combination, which can be done as a separate step and added to the oil or individually added to the oil, the Inventor has discovered that the final mixture of oil:emulsifiers should be about 99:1 to about 9:1. Levels above 99:1 do not allow adequate dispersion to take place and level below 9:1 cause gelling of the oil-emulsifier combination. The preferred ratio is about 12.333:1

It is to be understood, however, that even though numerous characteristics and advantages of the preferred and alternative embodiments have been set forth in the foregoing description, together with details of the structure and function of the embodiments, the disclosure is illustrative only, and changes may be made in detail within the principles of the invention to the full extent indicated by the broad general meaning of the terms in which the appended claims are expressed.

I claim:

1. A composition for increasing the bioavailability of oils in humans and animals comprising mixing a first emulsifier and a second emulsifier in a ratio ranging from about 1:1 to about 4:1 with a consumable oil.

2. The composition of claim 1 wherein the first emulsifier and the second emulsifier are mixed in a ratio of about 2:1.

3. The composition of claim 1 wherein the consumable oil is admixed with a mixture of the first emulsifier and the second emulsifier in a ratio ranging from about 99:1 to about 9:1.

4. The composition of claim 3 wherein the ratio is about 12.333:1.

5. The composition of claim 1 wherein the first emulsifier is polyoxyethylene sorbitan monooleate.

6. The composition of claim 1 wherein the second emulsifier is tocopheryl polyethylene glycol succinate.

7. The composition of claim 1 wherein the consumable oil is selected, either singly or in combination from the group comprising animal oils, vegetable oils, marine-based oils, and algae oils.

8. The oil of claim 7 wherein the consumable oil contain omega 3 fatty acids.

9. The omega 3 fatty acids of claim 8 including eicosapentaenoic acid and docosahexaenoic acid.

10. The composition of claim 1 wherein the first emulsifier and the second emulsifer have individual HLB values in the range of about 10 to about 30.

11. The composition of claim 10 wherein the first emulsifier and the second emulsifer have individual HLB values in the range of about 12 to about 16.

12. The first emulsifier and the second emulsifier of claim 10 wherein the first emulsifier and second emulsifier, when in combination, have an HLB value in the range of about 14 to about 14.6.

13. A composition for increasing the bioavailability of oils in humans and animals comprising mixing polyoxyethylene sorbitan monooleate and a second emulsifier in a ratio ranging from about 1:1 to about 4:1 with a consumable oil.

14. The composition of claim 13 wherein the polyoxyethylene sorbitan monooleate and the second emulsifier are mixed in a ratio of about 2:1.

15. The composition of claim 13 wherein the consumable oil is admixed with a mixture of the first emulsifier and the second emulsifier in a ratio ranging from about 99:1 to about 9:1.

16. The composition of claim 15 wherein the ratio is about 12.333:1.

17. The composition of claim 13 wherein the second emulsifier is tocopheryl polyethylene glycol succinate.

18. The composition of claim 13 wherein the consumable oil is selected, either singly or in combination from the group comprising animal oils, vegetable oils, marine-based oils, and algae oils.

19. The oil of claim 18 wherein the consumable oil contain omega 3 fatty acids.

20. The omega 3 fatty acids of claim 19 including eicosapentaenoic acid and docosahexaenoic acid.

21. The composition of claim 13 wherein the first emulsifier and the second emulsifer have individual HLB values in the range of about 10 to about 30.

22. The composition of claim 13 wherein the first emulsifier and the second emulsifer have individual HLB values in the range of about 12 to about 16.

23. The first emulsifier and the second emulsifier of claim 13 wherein the first emulsifier and second emulsifier, when in combination, have an HLB value in the range of about 14 to about 14.6.

24. A composition for increasing the bioavailability of oils in humans and animals comprising mixing a first emulsifier and tocopheryl polyethylene glycol succinate in a ratio ranging from about 1:1 to about 4:1 with a consumable oil.

25. The composition of claim 24 wherein the first emulsifier and the tocopheryl polyethylene glycol succinate are mixed in a ratio of about 2:1.

26. The composition of claim 24 wherein the consumable oil is admixed with a mixture of the first emulsifier and the second emulsifier in a ratio ranging from about 99:1 to about 9:1.

27. The composition of claim 25 wherein the ratio is about 12.333:1.

28. The composition of claim 24 wherein the first emulsifier is polyoxyethylene sorbitan monooleate.

29. The composition of claim 24 wherein the consumable oil is selected, either singly or in combination from the group comprising animal oils, vegetable oils, marine-based oils, and algae oils.

30. The oil of claim 29 wherein the consumable oil contain omega 3 fatty acids.

31. The omega 3 fatty acids of claim 30 including eicosapentaenoic acid and docosahexaenoic acid.

32. The composition of claim 24 wherein the first emulsifier and the second emulsifer have individual HLB values in the range of about 10 to about 30.

33. The composition of claim 24 wherein the first emulsifier and the second emulsifer have individual HLB values in the range of about 12 to about 16.

34. The first emulsifier and the second emulsifier of claim 24 wherein the first emulsifier and second emulsifier, when in combination, have an HLB value in the range of about 14 to about 14.6.

35. A method for increasing the bioavailability of consumable oil containing EPA comprising the steps of:
mixing a first emulsifier and a second emulsifier in a ratio ranging from about 1:1 to
about 4:1 with a consumable oil containing EPA to create a mixture and oil combination,
the ratio of oil containing EPA to first emulsifier and second emulsifier being from about
99:1 to about 9:1 with a resulting HLB range of about 10 to about 30;
consuming the first emulsifier, second emulsifier, and oil combination; and,
obtaining blood level concentrations of EPA of at least 0.250 mg/dl/hr.

36. The method of claim 35 including the step of selecting the first emulsifier as polyoxyethylene sorbitan monooleate.

37. The method of claim 35 including the step of selecting the second emulsifier as tocopheryl polyethylene glycol succinate.

38. The method of claim 35 including the step of selecting the consumable oil, either singly or in combination from the group comprising animal oils, vegetable oils, marine-based oils, and algae oils.
